(19) United States
(12) Patent Application Publication
(10) Pub. No.: US 2008/0047073 A1
(43) Pub. Date: Feb. 28, 2008

(54) DEVICE FOR HOLDING CAMSHAFT AGAINST ROTATION

(75) Inventor: ALAN JOHN MARTIN, SOLIHULL (GB)

Correspondence Address: FULWIDER PATTON LLP, HOWARD HUGHES CENTER, 6060 CENTER DRIVE, TENTH FLOOR, LOS ANGELES, CA, 90045, US

(73) Assignee: AUTO SERVICE TOOLS LIMITED, Redditch (GB)

(21) Appl. No.: 11/841,592

(22) Filed: Aug. 20, 2007

(30) Foreign Application Priority Data
Aug. 16, 2006 (GB) 0616276.2

(51) Int. Cl. B25F 1/00

(52) U.S. Cl. 7/100

(57) ABSTRACT

A device for holding a camshaft of an internal combustion engine in a required rotational position relative to an engine part, comprising a body adapted to be secured to the engine part, and at least two engagement parts, each having a portion engageable with a respective cam lobe part of a cam on the cam shaft, and being able to be set in a required one of a number of predetermined positions relative to the body.

### FIELD OF THE INVENTION

This invention relates to a device for holding a camshaft of an internal combustion engine against rotation, in a required rotational position, relative to an engine part.

### BBACKGROUND TO THE INVENTION

The invention has been devised for use when undertaking repair/servicing operations on certain engines, which operations require the or each camshaft of the engine to be held against rotation from a specific rotational position. Such operations may be ones where engine dismantling has taken place to the extent that the required relationship (“timing”) between the angular position of the camshaft(s) and the crankshaft of the engine has been disturbed. With overhead camshaft engines, cylinder head work can be expected to involve the removal of the or each camshaft or the means by which it or they are driven, and hence will require the timing to be reset on reassembly. As a routine matter, engines in which the camshaft(s) are driven by one or more toothed drive belts (timing belts) usually require replacement of such belt(s) at certain preset service intervals, and this may require the camshaft(s) to be held stationary in a predetermined angular position, so that after removal of the old belt(s) the fitting of new one(s) is done without the timed relationship between crankshaft and camshaft(s) being disturbed.

A camshaft for a multi-cylinder engine (or bank of cylinders in the case of an engine of Vee configuration), comprises a number of cams at spaced positions along the shaft usually with bearing journal portions of the shaft between some of the cams as well as at the ends thereof. Very often, the bearing journal portions of the camshaft run directly in complementary bearing parts of an aluminum alloy cylinder head, with removable bearing caps being secured to the head to support the camshaft for rotation. In some engines, the or each camshaft is held stationary in a required angular position by the removal of one of the bearing caps and the replacement thereof by a holding tool which has a portion which engages a lobe portion of an adjacent cam so that the camshaft cannot rotate out of the position in which it has the required timed relationship between the camshaft and crankshaft of the engine. When setting up the timing on a double overhead camshaft such engine, two of the holding devices are required to be used, one for each camshaft. A motor manufacturer may manufacture a “family” of engines whose basic geometry and dimensions are the same as or similar to one another, but for different engine capacities or even different states of tune of engine of the same capacity the cam profiles and dimensions may be quite different from one another. Thus there may be several different cam shafts involved, and for each different cam shaft different holding devices would be required to be used, to ensure that the cam shafts can be held in the correct positions. A mechanic or service establishment needing to work on such a family of engines would need to be equipped with suitable holding tools for all members of the family. This is inconvenient and expensive.

### SUMMARY OF THE INVENTION

It is broadly the object of the present invention to provide a holding device which is versatile in the sense of being able to be used with different camshafts, reducing the necessity for having a large number of different holding devices.

According to the present invention, we provide a device for holding a camshaft of an internal combustion engine in a required rotational position relative to an engine part, comprising a body adapted to be secured to the engine part, and at least two engagement parts, each having a portion engageable with a respective cam lobe part of a cam on the camshaft, and being able to be set in a required one of a number of predetermined positions relative to the body.

In a device according to the invention, the ability to set the engagement part(s) in respective ones of a number of predetermined positions, relative to the body of the device, means that the device is usable to hold camshafts whose cam lobe surfaces, of the cam which is being held, are differently shaped. Thus a device in accordance with the invention is usable to hold different camshafts instead of just one camshaft for which it is specifically designed.

The engagement part(s) may be pivotably mounted relative to the body of the device.

The or each engagement part may be settable in a required position relative to the body by a locating member engageable with formations of the body and the engagement parts. The locating member may comprise a pin, engageable with apertures in the engagement part and of the body.

Different camshafts with which a device according to the invention is intended to be used may differ from one another very little, so that required positions of the engagement parts relative to the body of the device, for use with different camshafts, are very close to one another. So that the engagement parts are able to be fixed in positions relative to the body which differ little from one another, there may be provided a number of formations in each engagement part and on adjacent parts of the body, so that different positions of the engagement part require engagement of the locating member with differently positioned formations on both the engagement part and the body.

The formations on the engagement parts and the body may be identified by appropriate markings, e.g. numerical and/or alphabetical.

In use of a device having these features, a user will identify the engine, and hence camshaft, with which the device is to be used and, from a reference source, determine that one engagement part will require to have its locating member engaged with particular formations on the one engagement part and on the body, while the other engagement part will require to have its locating member engaged with other particular formations on the engagement part and on the body. For another camshaft or engine, each of the engagement parts will require to have its locating member engaged with a different formation on the respective engagement part and on the body.

Thus in accordance with the invention a device is able to be adjusted in respect of the positioning of its engagement parts so that it is able to hold several different camshafts in required positions.

### BRIEF DESCRIPTION OF THE DRAWINGS

The invention will now be described by way of example with reference to the accompanying drawings of which:

FIG. 1 is a diagrammatic perspective view of part of a cylinder head of an internal combustion engine, illustrating the use of previously-known tools in setting the timing thereof.

FIG. 2 is an exploded perspective view of a device in accordance with the invention.

FIGS. 3 and 4 are elevations of the device of FIG. 2, with engagement parts thereof in different positions relative to the body part thereof.

FIG. 5 is a perspective view of the device with the engagement parts thereof in yet further relative positions.

### DESCRIPTION OF PREFERRED EMBODIMENTS

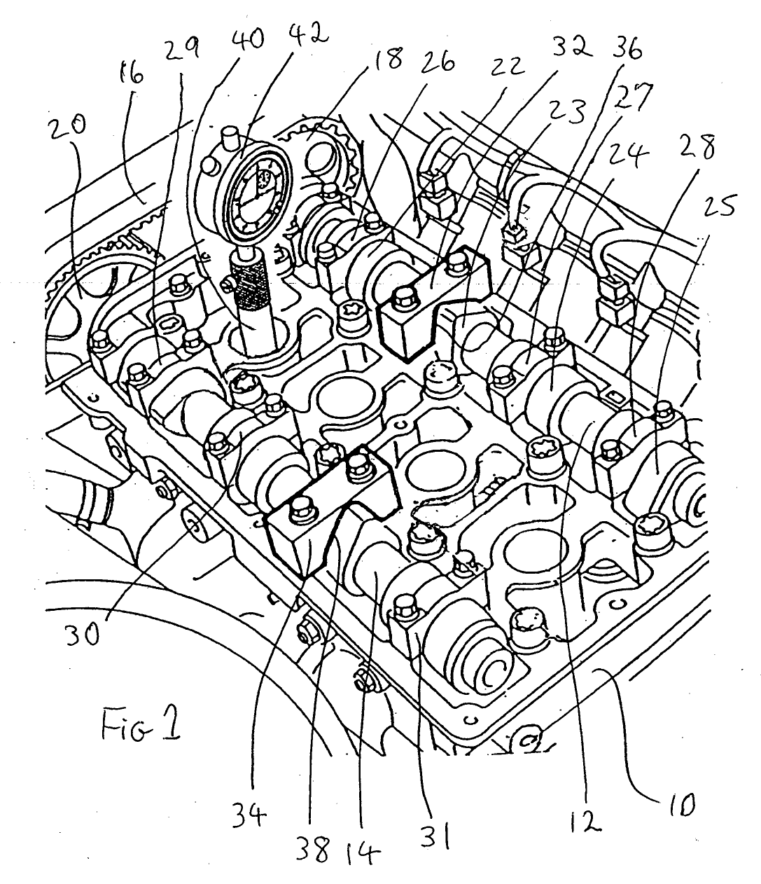

Referring firstly to FIG. 1 of the drawings this illustrates, diagrammatically, how camshaft timing may be set in known manner, for a four cylinder internal combustion engine of the double overhead cam type. In this figure, the cylinder head is indicated at 10 and the inlet and exhaust camshafts at 12, 14 respectively. The camshafts are driven by a timing belt 16 entrained around toothed pulleys or sprockets 18, 20 on the respective camshafts, the belt 16 being driven from the crankshaft of the engine. The camshafts have cams which operate the respective inlet and exhaust valves of the engine in known manner; cams for operating the inlet valves of numbers 1 to 4 cylinders are indicated at 22, 23, 24, 25 on the inlet camshaft 12. The cams are, of course, all differently angularly positioned from one another on the camshaft, so that they operate their respective valves in the correct timed relation to the crank angle (and hence piston position) of the cylinders in question.

The cam shafts are supported relative to the cylinder head 10 for rotation about their respective longitudinal axes by journal bearings, the camshafts having a number of journal portions appropriately spaced along their length which are received in bearing parts of the cylinder head, and are retained by bearing caps as indicated at 26, 27, 28 for the inlet camshaft 12, and 29, 30, 31 for the exhaust camshaft 14. Further such bearing caps have been replaced by holding devices of known type, for the purpose of timing the engine, one such holding device being indicated at 32 for the inlet camshaft 12 and another being indicated at 34 for the exhaust camshaft 14.

The holding device 32 fits in place of the respective bearing cap, being bolted to the cylinder head temporarily when the timing of the engine is being set. The holding device has a bearing portion which faces the corresponding bearing portion in the cylinder head, and holds the respective bearing journal portion of the camshaft between it and the bearing part of the cylinder head. The holding device has a recess whose shape is clearly indicated at 34, into which the lobe portion of the inlet cam 23 of number 2 cylinder fits, so that the camshaft 12 is held in a fixed position relative to the cylinder head. Similarly, the holding device 34 has a recess 38 (which it will be noted is of different shape from the recess 36) into which the lobe portion of the exhaust cam of number 3 cylinder fits, so that the exhaust cam shaft 14 is held in a required angular position relative to the cylinder head. Also shown in FIG. 1 is a device for indicating top dead centre on number 1 cylinder of the engine, comprising a body 40 which fits in the spark plug opening of that cylinder and carries a dial test indicator 42 whose sensing element reaches down to contact the crown of the piston in that cylinder. With the crankshaft of the engine set so that the piston in number 1 cylinder is at top dead centre, and the camshafts held as illustrated, the timing belt pulleys 18, 20 can be secured to the camshafts and the belt fitted so that the camshaft timing of the engine is correctly set. Thereafter, the holding devices 32, 34 can be removed and replaced by the appropriate bearing caps, and engine assembly continued.

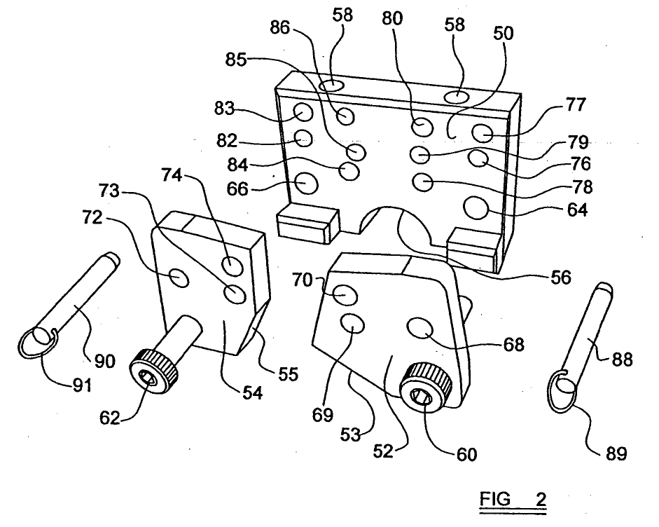

Referring now to FIG. 2 of the drawings, a holding device in accordance with the invention comprises a body 50 and two engagement parts 52, 54. The body 50 is a block of metal e.g. of an aluminum alloy, and is generally rectangular in front elevation, having a substantially semicircular recess 56 in its lower surface, which enables the holding device to be bolted to a cylinder head in replacement for one of the camshaft bearing caps thereof, with the recess 56 facing one of the journal portions of a camshaft: it may contact the journal portion of the camshaft. Apertures 58 extending vertically through the body 50 provide for the accommodation of bolts by which it can be bolted to the cylinder head, such bolts engaging the threaded bores in the head which are engaged by the fixing bolts of the bearing cap which has been removed.

The engagement parts 52, 54 are elements of metal plate e.g. steel, and have engagement surface parts 53, 55 respectively. They are each pivotally secured to the body 50, by bolts 60, 62 which extend through the parts 52, 54 and into apertures 64, 66 respectively in the body 50. The engagement part 52 is provided with three apertures 68, 69, 70 extending through it, and the engagement part 54 with apertures 72, 73, 74.

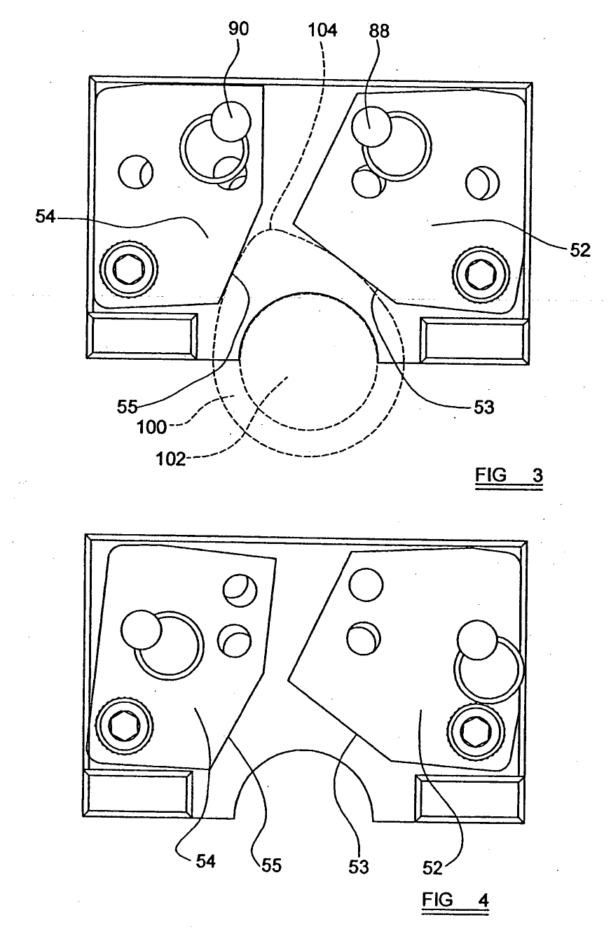

The body part 50 is provided with five apertures 76, 77, 78, 79, 80 in the vicinity of the engagement part 52 and with a further five such apertures 82, 83, 84, 85, 86 in the vicinity of the engagement part 54. The diameters of all the apertures 68 to 74 in the engagement parts and 76 to 86 in the body part are such as to receive, as a close sliding fit, locating elements in the forms of pins 88, 90. The pins 88, 90 have retaining rings 89, 91 respectively, enabling the pins to be connected to lengths of string, wire, or the like so that in use, bearing in mind they are relatively small parts, they are not likely to be dropped into passages or inaccessible spaces inside an engine, or at least to facilitate their retrieval if this occurs. The positioning of the apertures is such that the engagement members are able to set in respective ones of a number of predetermined positions relative to the body, and such positions are shown in the illustrations of FIGS. 3 to 5.

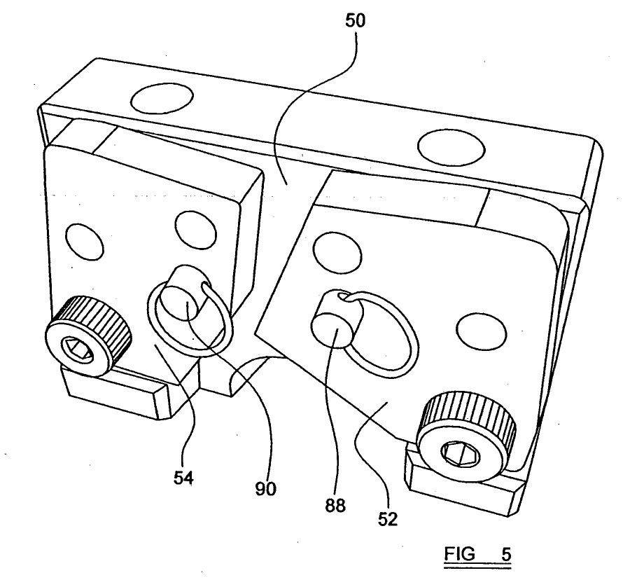

FIG. 3 shows the engagement parts 52, 54 pivoted so that aperture 70 in the member 52 is aligned with aperture 80 in the body 50, and aperture 74 in the member 54 with aperture 86 in the body 50, the pins 88, 90 being placed in the respective aligned apertures. The position of the engagement surface 53, 55 will be noted. FIG. 3 also shows, in outline, a cam 100 on a camshaft 102, with the engagement surfaces 53, 55 contacting cam surfaces on opposite sides of the peak 104 of the lobe portion of the cam. FIG. 4 shows the pin 88 engaged with apertures 68 and 76 in the engagement part 52 and body 50 and the pin 90 engaged with apertures 72 and 82 in the engagement part 54 and body 50, respectively. FIG. 5 shows the pin 88 engaged with aperture 69 and aperture 79 in the part 52 and body 50, respectively, and pin 90 engaged with apertures 73 and 85 in the part 54 and body 50 respectively. Thus the engagement surfaces 53, 55 of the parts 52, 54 are set in respective further positions relative to the body 50, enabling the device to hold cams whose lobes are differently shaped from that with which they engage when set as in FIG. 3.

The invention thus provides a holding device of considerable versatility, able to be used with different engines or camshafts or a family thereof. The necessity for a mechanic or service establishment to have a large number of separate holding devices is reduced.

Although not shown in the drawings, it is envisaged that the apertures respectively in the parts 52, 54 and in the body 50 will be identified by adjacent markings such as letters and/or numbers. When the holding device is to be used, a person using it will, firstly, identify the engine with which it is to be used and hence the cam shaft(s) fitted. From a reference source, it will identified that the engagement parts are required to be fitted as shown in FIG. 3 (for example), and the user will so position the engagement parts and place the pins 88, 90 through the appropriate apertures in the engagement member and body. For a different engine, the reference source will indicate how the engagement parts and locating pins should be differently disposed.

It would be possible, to enable use of the device with a greater number of engines in a family, to provide a common body 50 and two or more sets of engagement parts 52, 54 usable therewith. It will of course be appreciated that there may be different numbers of the apertures in the engagement parts and body, with which the locating members constituted by pins 88, 90 are engageable. A set of holding devices, for use with a double overhead camshaft engine, would comprise two bodies and associated pairs or sets of pairs of engagement parts.

In general, while it would be within the broadest scope of the invention for there to be a single engagement part able to be set in a number of positions relative to the body of the device, the provision of two engagement parts, with engagement surfaces appropriately shaped to engage two different parts of the lobe part of a cam on a cam shaft, on either side of the peak thereof, will provide greater versatility to ensure correct positioning of a cam and hence the camshaft on which it is provided. Possibly more engagement parts could be provided to increase further the versatility of the holding device.

It is convenient for the locating members to comprise pins as above described extending through open apertures in the engagement members and body of the device. However, it would be possible to use locating members in the form of pins or of other configuration engaging with notches, recesses, or blind bores in the body or engagement parts.

It is envisaged a device or number of devices in accordance with the invention could be supplied as a kit for use with a particular family of engines, together with suitable instructions as to the setting of the device(s) for use with particular engines.

When used in this specification and claims, the terms “comprises” and “comprising” and variations thereof mean that the specified features, steps or integers are included. The terms are not to be interpreted to exclude the presence of other features, steps or components.

The features disclosed in the foregoing description, or the following claims, or the accompanying drawings, expressed in their specific forms or in terms of a means for performing the disclosed function, or a method or process for attaining the disclosed result, as appropriate, may, separately, or in any combination of such features, be utilised for realising the invention in diverse forms thereof.

1. A device for holding a camshaft of an internal combustion engine in a required rotational position relative to an engine part, comprising a body adapted to be secured to the engine part, and at least two engagement parts, each having a portion engageable with a respective cam lobe part of a cam on the cam shaft, and being able to be set in a required one of a number of predetermined positions relative to the body.

2. A device according to claim 1 wherein the engagement parts are pivotably mounted relative to the body of the device.

3. A device according to claim 1 or claim 2 further characterised in that at least portions of the engagement parts align with one another transversely of the camshaft when the device is in use.

4. A holding device according to claim 1 wherein each engagement part is settable in a required position relative to the body by a locating member engageable with formations of the body and of the engagement part.

5. A holding device according to claim 4 wherein the formations comprise apertures in the engagement part and the body, and each locating member comprises a pin engageable with such apertures.

6. A holding device according to claim 4 comprising a number of the formations in each engagement member and on adjacent parts of the body, so that different positions of an engagement part require engagement of the locating member with differently positioned formations on both the engagement part and the body.

7. A holding device according to claim 6 wherein the formations of the engagement part of the body are identified by associated numerical and/or alphabetical markings.

8. A kit of tools for use on an internal combustion engine, including at least one holding device for holding a camshaft of the internal combustion engine in a required rotational position relative to an engine part, comprising a body adapted to be secured to the engine part, and at least two engagement parts, each having a portion engageable with a respective cam lobe part of a cam on the cam shaft, and each being able to be set in a required one of a number of predetermined positions relative to the body, and a source of information as to the required positions in which the engagement parts of the device are required to be set relative to the body thereof for use with the engine.

9. A kit of tools according to claim 8 comprising at least two of the holding devices.

10. A method of holding a camshaft of an internal combustion engine in a required rotational position relative to an engine part, comprising providing a device having a body adapted to be secured to the engine part, and at least two engagement parts, each having a portion engageable with a respective cam lobe part of a cam on the cam shaft, and each being able to be set in a required one of a number of predetermined positions relative to the body, providing a source of information which is relevant to the engine of which at least one camshaft is to be held in a required rotational position relative to a part of the engine, relating to the required positions in which the engagement parts of the device are required to be set relative to the body of the device, setting the engagement parts in the required positions relative to the body, and attaching the holding device to the engine.
